(19) United States
(12) Patent Application Publication
(10) Pub. No.: US 2010/0173115 A1
(43) Pub. Date: Jul. 8, 2010

(54) ULTRAVIOLET CURABLE COMPOSITION FOR OPTICAL DISC INTERMEDIATE LAYER, OPTICAL DISC, AND METHOD FOR MANUFACTURING OPTICAL DISC

(75) Inventors: Takeshi Isonaka, Saitama (JP); Daisuke Ito, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: DIC CORPORATION, Tokyo (JP)

(21) Appl. No.: 12/377,001

(22) PCT Filed: Jul. 31, 2007
(86) PCT No.: PCT/JP2007/064923

§ 371 Date: Feb. 10, 2009

(30) Foreign Application Priority Data
Aug. 11, 2006 (JP) 2006-219689
Aug. 11, 2006 (JP) 2006-219690
Aug. 11, 2006 (JP) 2006-219691

(51) Int. Cl. G11B 7/252; B29C 35/08; B32B 37/14; C08F 2/46

(52) U.S. Cl. 428/65.1; 264/496; 156/242; 522/182

(57) ABSTRACT

An ultraviolet curable composition comprising a polyfunctional meth)acrylate having three or more (meth)acryloyl groups per molecule, a difunctional (meth)acrylate having two (meth)acryloyl groups per molecule, and a monofunctional (meth)acrylate having one (meth)acryloyl group per molecule, wherein the content of the polyfunctional (meth)acrylate in the (meth)acrylates contained in the ultraviolet curable composition is 30 to 70% by mass, the content of the monofunctional (meth)acrylate is 5 to 30% by mass, the total content of a difunctional (meth)acrylate having an alicyclic structure and a monofunctional (meth)acrylate having an alicyclic structure is 10 to 50% by mass, and the content of a methacrylate is 7% by mass or more exhibits good separation when separated from a stamp. A resultant cured film can be separated from a stamp made of a general-purpose resin while maintaining useful characteristics such as heat resistance and the like for an intermediate layer of an optical disc.

### BACKGROUND OF THE INVENTION

1. Field of the Invention

The present invention relates to an ultraviolet curable composition used for intermediate layers for forming concave-convex patterns of optical discs such as DVD, HD-DVD, Blu-ray Disc, and the like.

2. Description of Related Art

In recent years, optical discs with multilayer structures including a plurality of information recording layers have been widely used with the requirement for increasing the capacities of optical discs such as DVD, HD-DVD, Blu-ray Disc, and the like. Multilayer optical discs generally have a structure in which pluralities of information recording layers are laminated with intermediate layers provided between the respective information recording layers. Specifically, a first information recording layer is provided on a substrate, an intermediate layer having a convex-concave pattern formed on a surface thereof is laminated on the first information recording layer, and further a second information recording layer is laminated so that the concave-convex pattern of the intermediate layer is transferred to the second information recording layer. The concave-convex pattern of the intermediate layer is generally formed by a 2P (Photo Polymerization) method in which a resin layer used as the intermediate layer is pressed with a stamp (refer to Patent Document 1).

When a concave-convex pattern is transferred from a stamp to an intermediate layer to form the intermediate layer, low detachability of the stamp to be separated from the intermediate layer causes separation of a portion of the intermediate layer together with the stamp, thereby causing a defect. Therefore, polyolefin stamps have been widely used because of the high detachability from various ultraviolet curable resins used for intermediate layers (refer to Patent Documents 2 and 3). Such polyolefin stamps have high detachability from various ultraviolet curable resins, but they cannot be easily actually reused because of high cost and the need for washing the resins adhering to the surfaces in order to reuse the stamps. Therefore, there is a demand for conversion to a stamp composed of an inexpensive resin such as polycarbonate or the like.

As an ultraviolet curable resin used for conventional optical discs, for example, an ultraviolet curable composition containing a bisphenol A ethylene oxide adduct is disclosed (refer to Patent Document 4). The composition contains a compound having a specified structure and produces a cured product which permits sufficient transfer of a reflecting film because the cured product has specified elastic modulus. Also, a resin composition for bonding information recording media is disclosed, which contains specified epoxy(meth)acrylate, a (meth)acryloyl group-containing compound, and a photopolymerization initiator, and thus exhibits high reliability and no appearance change even when gold, silver, or silicon nitride is used for an information recording layer (refer to Patent Document 5).

However, when these conventional resin compositions are used for intermediate layers such as light-transmitting layers of optical discs and a general-purpose resin such as polycarbonate or the like is used for stamps, the intermediate layers partially remain on the stamps due to low detachability of the stamps when separated therefrom. Thus, there occurs the problem of causing deformation or defects in concave-convex patterns including pits, grooves, and the like formed in the intermediate layers.

[Patent Document 1] Japanese Unexamined Patent Application Publication No. 09-161329

[Patent Document 2] Japanese Unexamined Patent Application Publication No. 2003-085839

[Patent Document 3] Japanese Unexamined Patent Application Publication No. 2005-166241

[Patent Document 4] Japanese Unexamined Patent Application Publication No. 2005-243109

[Patent Document 5] Japanese Unexamined Patent Application Publication No. 2005-048095

### BRIEF SUMMARY OF THE INVENTION

The present invention provides an ultraviolet curable composition which causes little deformation or defects in a concave-convex pattern and little cracks in a disc even when an inexpensive general-purpose resin such as polycarbonate or the like is used for a stamp and which thus has useful characteristics for an intermediate layer of an optical disc. Further, the present invention provides a method for manufacturing an optical disc with a multilayer structure, in which an inexpensive general-purpose resin such as polycarbonate or the like can be used as a stamp.

An ultraviolet curable composition of the present invention can form many crosslinking points by a polyfunctional (meth)acrylate, can preferably control the crosslinking density and hardness over the whole of a cured film by a monofunctional (meth)acrylate and a (meth)acrylate having an alicyclic structure, and can exhibit good separation behaviors when separated from a stamp. Further, detachability of a cured film surface from a general-purpose resin is improved by a methacrylate having a methyl group at a reactive site and the (meth)acrylate having an alicyclic structure. When specified amounts of these (meth)acrylates are mixed, a resultant cured film can be desirably separated from the stamp made of a general-purpose resin while maintaining useful characteristics such as heat resistance and the like for an intermediate layer of an optical disc. Consequently, when the ultraviolet curable composition of the present invention is applied to an optical disc intermediate layer, there occurs minimal cracking in the disc or deformation or defects in a concave-convex pattern when the stamp is separated.

That is, the present invention provides an ultraviolet curable composition for an optical disc intermediate layer, the composition containing a polyfunctional (meth)acrylate having three or more (meth)acryloyl groups per molecule, a difunctional (meth)acrylate having two (meth)acryloyl groups per molecule, and a monofunctional (meth)acrylate having one (meth)acryloyl group per molecule. The content of the polyfunctional (meth)acrylate in the (meth)acrylates contained in the ultraviolet curable composition is 30 to 70% by mass, the content of the monofunctional (meth)acrylate is 5 to 30% by mass, the total content of the difunctional (meth)acrylate having an alicyclic structure and the monofunctional (meth)acrylate having an alicyclic structure is 10 to 50% by mass, and the content of a methacrylate is 7% by mass or more.

Also, the present invention provides an optical disc having at least one information recording layer provided on a substrate, and a light-transmitting layer as an intermediate layer between the substrate and the information recording layer or between adjacent two information recording layers, light-transmitting layer being composed of a cured product of the ultraviolet curable composition for an optical disc intermediate layer.

Further, the present invention provides a method for manufacturing an optical disc recoding medium including at least a first information recording layer, a first light reflecting layer, an intermediate layer, a second information recording layer, and a second light reflecting layer which are laminated in order on a substrate. The method includes:

(1) a step of forming the first information recording layer and the first light reflecting layer on the substrate;

(2) a step of bonding the ultraviolet curable composition for an optical disc intermediate layer between the first light-reflecting layer and a stamp having a concave-convex pattern on a surface thereof, at least the surface having the concave-convex pattern being composed of polycarbonate, irradiating the ultraviolet curable composition with ultraviolet light to form the intermediate layer composed of a cured product of the ultraviolet curable composition intermediate layer, and then separating the intermediate layer from the stamp to form the intermediate layer having the concave-convex pattern formed thereon; and

(3) a step of forming the second information recording layer and the second light-reflecting layer on the intermediate layer.

### Advantages

An ultraviolet curable composition for an optical disc intermediate layer of the present invention can provide a cured product having high detachability from polycarbonate and can thus form a good concave-convex pattern without using an expensive olefin resin as a stamp. Further, the ultraviolet curable composition for an optical disc intermediate layer can realize high elastic modulus and thus can be preferably used for an intermediate layer in which pre-pits and grooves of an optical disc are formed.

A method for manufacturing an optical disc using the ultraviolet curable composition for an optical disc intermediate layer of the present invention is capable of preferably manufacturing an optical disc without using an expensive olefin resin and thus capable of manufacturing an optical disc at low cost.

### BRIEF DESCRIPTION OF DRAWINGS

FIG. 1 is a drawing showing an example of a dual-layer optical disc according to the present invention;

FIG. 2 is a drawing showing an example of a dual-layer optical disc according to the present invention;

FIG. 3 is a drawing showing an example of a three-layer optical disc according to the present invention; and

FIG. 4 is a drawing showing an example of a three-layer optical disc according to the present invention

### REFERENCE NUMERALS

1 substrate (d₁)
2 dye recording layer (a₁)
3 semitransparent light-reflecting layer (t₁)
4 light-transmitting layer (c₁ of ultraviolet curable composition
5 dye recording layer (b)
6 light-reflecting layer (r)
7 substrate (d₂)
8 adhesive layer
11 convex recording track (groove)
12 convex recording track (groove)
13 convex recording track (groove)
21 first recording layer including a laminate of dye recording layer (a₁) 2 and semitransparent light-reflecting layer (t₁) 3
22 second recording layer including a laminate of dye recording layer (b) 5 and light-reflecting layer (r) 6
23 laminate (s)
31 dye recording layer (a₂)
32 semitransparent light-reflecting layer (t₂)
33 light-transmitting layer (c₂) of ultraviolet curable composition
41 light-transmitting layer (c₃)
42 light-transmitting layer (c₄)
43 light-transmitting layer (c₅)
44 light-transmitting layer (c₆).

### DETAILED DESCRIPTION OF THE INVENTION

### [Ultraviolet Curable Composition]

An ultraviolet curable composition for an optical disc intermediate layer of the present invention contains a polyfunctional (meth)acrylate having three or more (meth)acryloyl groups per molecule (hereinafter abbreviated as a “polyfunctional (meth)acrylate”), a difunctional (meth)acrylate having two (meth)acryloyl groups per molecule (hereinafter abbreviated as a “difunctional (meth)acrylate”), and a monofunctional (meth)acrylate having one (meth)acryloyl group per molecule. The content of the polyfunctional (meth)acrylate in the (meth)acrylates contained in the ultraviolet curable composition is 30 to 70% by mass, the content of the monofunctional (meth)acrylate is 5 to 30% by mass, the total content of the difunctional (meth)acrylate having an alicyclic structure and the monofunctional (meth)acrylate having an alicyclic structure is 10 to 50% by mass, and the content of methacrylate is 7% by mass or more. In the specification, the term “(meth)acrylate” represents acrylate or methacrylate. Similarly, the term “(meth)acryloyl group” represents an acryloyl group or a methacryloyl group. In addition, the term “intermediate layer” represents a layer such as a light-transmitting layer provided in a portion of an optical disc other than the front and back surfaces thereof, the layer having other layers provided on the front and back surfaces thereof.

(Polyfunctional (meth)acrylate)

The ultraviolet curable composition of the present invention contains 30 to 70% by mass, preferably 40 to 70% by mass, and more preferably 50 to 70% by mass of polyfunctional (meth)acrylate based on 100% by mass of (meth)acrylates contained in the ultraviolet curable composition. The ultraviolet curable composition of the present invention contains the polyfunctional (meth)acrylate at a high content, and thus a rigid cured film can be obtained, thereby contributing to improvement in detachability from general-purpose resins such as polycarbonate and the like. In addition, the cured film is very hard even at high temperatures and has a high glass transition temperature, thereby causing substantially no deformation even when subjected to heat during recording. Therefore, the ultraviolet curable composition of the present invention can provide a cured product having preferred detachability and heat resistance for an intermediate layer of an optical disc.

Preferred examples of the polyfunctional (meth)acrylate used in the preset invention include bis(2-acryloyloxyethyl)hydroxyethyl isocyanurate, bis(2-acryloyloxypropyl)hydroxypropyl isocyanurate, bis(2-acryloyloxybutyl)hydroxybutyl isocyanurate, bis(2-methacryloyloxyethyl)hydroxyethyl isocyanurate, bis(2-methacryloyloxypropyl)hydroxypropyl isocyanurate, bis(2-methacryloyloxybutyl)hydroxybutyl isocyanurate, tris(2-acryloyloxyethyl)isocyanurate, tris(2-acryloyloxypropyl)isocyanurate, tris(2-acryloyloxybutyl)isocyanurate, tris(2-methacryloyloxyethyl)isocyanurate, tris(2-methacryloyloxypropyl)isocyanurate, tris(2-methacryloyloxybutyl)isocyanurate, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, di- or tri-(meth)acrylate of triol produced by adding at least 3 moles of ethylene oxide or propylene oxide to 1 mole of trimethylol propane, dipentaerythritol poly(meth)acrylate, and the like. These polyfunctional (meth)acrylates can exhibit high elastic modulus after curing.

Among these, tris(2-acryloyloxyethyl)isocyanurate, tris(2-methacryloyloxyethyl)isocyanurate, trimethylolpropane tri(meth)acrylate, ditrimethylolpropane tetraacrylate, pentaerythritol tri(meth)acrylate, pentaerythritol tetra(meth)acrylate, dipentaerythritol penta(meth)acrylate, and dipentaerythritol hexa(meth)acrylate are more preferred because particularly high elastic modulus can be achieved after during. Dipentaerythritol penta(meth)acrylate, dipentaerythritol hexa(meth)acrylate, tris(acryloyloxyethyl)isocyanurate, and the like are most preferred.

(Difunctional (meth)acrylate)

The ultraviolet curable composition of the present invention contains a difunctional (meth)acrylate and thus viscosity of the ultraviolet curable composition and physical properties of a resultant cured product can be controlled in ranges suitable for an optical disc.

Examples of the difunctional (meth)acrylate used in the present invention include difunctional (meth)acrylates having an alicyclic structure, such as norbornanedimethanol di(meth)acrylate, norbornanediethanol di(meth)acrylate, di(meth)acrylate of diol produced by adding 2 moles of ethylene oxide or propylene oxide to norbornanedimethanol, tricyclodecanedimethanol di(meth)acrylate, tricyclodecanediethanol di(meth)acrylate, di(meth)acrylate of diol produced by adding 2 moles of ethylene oxide or propylene oxide to tricyclodecanedimethanol, pentacyclopentadecanedimethanol di(meth)acrylate, pentacyclopentadecanediethanol di(meth)acrylate, di(meth)acrylate of diol produced by adding 2 moles of ethylene oxide or propylene oxide to pentacyclopentadecanedimethanol, di(meth)acrylate of diol produced by adding 2 moles of ethylene oxide or propylene oxide to pentacyclopentadecanediethanol, dimethyloldicyclopentane di(meth)acrylate, and the like.

Examples of other difunctional (meth)acrylates include 1,4-butanediol di(meth)acrylate, 3-methyl-1,5-pentanediol di(meth)acrylate, 1,6-hexanediol di(meth)acrylate, neopentyl glycol di(meth)acrylate, 2-methyl-1,8-octanediol di(meth)acrylate, 2-butyl-2-ethyl-1,3-propanediol di(meth)acrylate, ethylene glycol di(meth)acrylate, trimethylolpropane tri(meth)acrylate, pentaerythritol tri(meth)acrylate, propylene glycol di(meth)acrylate, di(meth)acrylate of diol produced by adding at least 4 moles of ethylene oxide or propylene oxide to one mole of neopentyl glycol, ethylene oxide-modified phosphoric acid (meth)acrylate, ethylene oxide-modified alkylated phosphoric acid (meth)acrylate, diethylene glycol di(meth)acrylate, dipropylene glycol di(meth)acrylate, tripropylene glycol di(meth)acrylate, polyether (meth) acrylate, diethylaminoethyl(meth) acrylate, N-vinylpyrrolidone, N-vinylcaprolactam, vinyl ether monomers, an the like.

Among these, tricyclodecanedimethanol di(meth)acrylate and pentacyclopentadecanedimethanol di(meth)acrylate are preferred, and tricyclodecanedimethanol di(meth)acrylate is particularly preferred.

Difunctional (meth)acrylates represented by the following formula (1) can be preferably used because high detachability from polycarbonate and the like can be imparted to the resultant cured product.

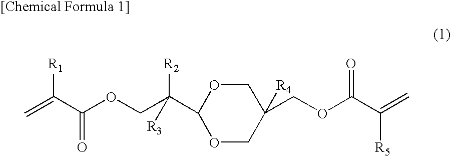

(wherein R₁ and R₂ each represent a hydrogen atom or a methyl group, and R₂ to R₄ each independently represent a hydrogen atom or an alkyl group having 1 to 5 carbon atoms).
(Monofunctional (meth)acrylate)

The (meth)acrylates contained in the ultraviolet curable composition of the present invention contain 5 to 30% by mass, preferably 5 to 25% by mass, and more preferably 5 to 20% by mass of monofunctional (meth)acrylate. When the monofunctional (meth)acrylate at this content is combined with a trifunctional (meth)acrylate, the crosslinked structure of the cured film can be preferably controlled to decrease adhesion to resins such as polycarbonate and the like.

Examples of a monofunctional (meth)acrylate having an alicyclic structure include isobornyl(meth)acrylate, norbornyl(meth)acrylate, 2-(meth)acryloyloxymethyl-2-methylbicycloheptane adamantyl(meth)acrylate, dicyclopentenyl(meth)acrylate, dicyclopentanyl(meth)acrylate, dicyclopentenyloxyethyl(meth)acrylate, tetracyclododecanyl(meth)acrylate, cyclohexyl(meth)acrylate, and the like.

Examples of other monofunctional (meth)acrylates include ethyl(meth)acrylate, butyl(meth)acrylate, 2-ethylhexyl(meth)acrylate, nonyl(meth)acrylate, tridecyl(meth)acrylate, hexadecyl(meth)acrylate, octadecyl(meth)acrylate, isoamyl(meth)acrylate, isodecyl(meth)acrylate, isostearyl(meth)acrylate, 2-hydroxyethyl(meth)acrylate, 3-chloro-2-hydroxypropyl(meth)acrylate, methoxyethyl(meth)acrylate, butoxyethyl(meth)acrylate, benzyl(meth)acrylate, nonylphenoxyethyl(meth)acrylate, tetrahydrofurfuryl(meth)acrylate, glycidyl(meth)acrylate, 2-hydroxy-3-phenoxypropyl(meth)acrylate, nonylphenoxyethyltetrahydrofurfuryl(meth)acrylate, caprolactone-modified tetrahydrofurfuryl(meth)acrylate, acryloyl morpholine, phenoxyethyl(meth)acrylate, and the like.

Among these, isobornyl(meth)acrylate, dicyclopentenyl(meth)acrylate, and dicyclopentanyl(meth)acrylate are preferred. In particular, isobornyl acrylate and isobornyl methacrylate are preferred. Among these, isobornyl methacrylate is most preferred because it forms a cured film having more rigidity and a cured product having excellent detachability from polycarbonate.

((Meth)acrylate having Alicyclic Structure)

The (meth)acrylates contained in the ultraviolet curable composition of the present invention contains a difunctional (meth)acrylate having an alicyclic structure and a monofunctional (meth)acrylate having an alicyclic structure at a total content of 10 to 50% by mass, preferably 20 to 50% by mass, more preferably 25 to 45% by mass, and most preferably 30 to 45% by mass. When (meth)acrylates having an alicyclic structure are contained in the above-mentioned range, the (meth)acrylates can provide high elastic modulus and a high glass transition temperature together with three- and higher-functional acrylates at a high temperature because the (meth)acrylates have a rigid cyclic structure. When a (meth)acrylate not having a polar group is used, adhesion to resins such as polycarbonate can be decreased.

In the present invention, the content of (meth)acrylates having an alicyclic structure can be appropriately adjusted by using the difunctional (meth)acrylate having an alicyclic structure and the monofunctional (meth)acrylate having an alicyclic structure as part or the whole of the difunctional (meth)acrylate and the monofunctional (meth)acrylate used for the ultraviolet curable composition.

As the difunctional (meth)acrylate having an alicyclic structure, tricyclodecanedimethanol di(meth)acrylate and pentacyclopentadecanedimethanol di(meth)acrylate are preferred, and tricyclodecanedimethanol di(meth)acrylate is particularly preferred. As the monofunctional (meth)acrylate, isobornyl(meth)acrylate, dicyclopentenyl(meth)acrylate, and dicyclopentanyl (meth)acrylate are preferred. In particular, isobornyl acrylate and isobornyl methacrylate are preferred. Among these, isobornyl methacrylate is most preferred because a cured film is made rigid, and a cured product has excellent detachability from polycarbonate.

In addition, the total content of the polyfunctional (meth)acrylate, the difunctional (meth)acrylate having an alicyclic structure, and the monofunctional (meth)acrylate having an alicyclic structure in the (meth)acrylates is preferably 60% by mass or more.

### (Methacrylate)

When the (meth)acrylates used in the ultraviolet curable composition of the present invention contain 7% by mass or more of methacrylate, high detachability from a general-purpose resin such as polycarbonate can be imparted to a cured film. The upper limit of the content of methacrylate is not particularly limited, but when the amount of methacrylate is large, curability tends to decease. Therefore, the amount of methacrylate is preferably 75% by mass or less, more preferably 7 to 45% by mass, and most preferably 10 to 30% by mass. In particular, a monofunctional methacrylate is preferably used as the methacrylate in order to improve detachability. The content of monofunctional methacrylate is preferably 7% by mass or more, more preferably 10% by mass.

In the present invention, the content of methacrylate can be appropriately adjusted using methacrylate as part of the (meth)acrylates used in the ultraviolet curable composition.

As the methacrylate, tricyclodecanedimethanol dimethacrylate, isobornyl methacrylate, dicyclopentenyl methacrylate, and dicyclopentanyl methacrylate are preferred. In particular, isobornyl methacrylate is most preferred because a cured film is made rigid, and a cured product has very excellent detachability from polycarbonate.

### ((Meth)acrylate Oligomer)

The ultraviolet curable composition of the present invention may contain (meth)acrylate oligomer besides the (meth)acrylates. As the (meth)acrylate oligomer, epoxy (meth)acrylate is preferred because it has a rigid structure and thus improves detachability from polycarbonate.

As the epoxy(meth)acrylate used in the present invention, any epoxy(meth)acrylate having the above-described characteristics can be used. For example, bisphenol-type epoxy(meth)acrylate represented by the following formula (2) can be used.

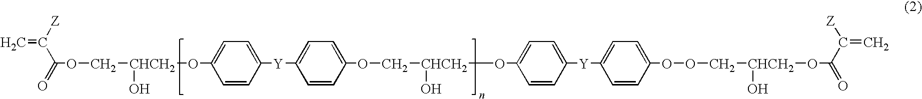

(wherein Y represents —SO₂—, —CH₂—, —CH(CH₃)—, or —C(CH₃)₂—, Z independently represents a hydrogen atom or —CH₃, and n represents 0 or an integer of 1 or more.)

Examples of such bisphenol-type epoxy(meth)acrylate include epoxy acrylate obtained by reaction between bisphenol A epoxy resin, such as Yuka Shell Epoxy Co., EPICOAT 802, 1001, 1004, or the like, bisphenol F epoxy resin, such as EPICOAT 4001P, 4002P, 4003P, or the like, and (meth)acrylic acid.

In particular, bisphenol A epoxy(meth)acrylate containing an addition polymerization product as a main component in which Y is —C(CH₃)₂— and n is 0 or an integer of 1 to 6 is more preferred.

Also, hydrogenated bisphenol A-type and bisphenol F-type epoxy(meth)acrylate can be preferably used.

The epoxy(meth)acrylate used in the present invention preferably has a weight-average molecular weight (Mw) of 500 to 3000, more preferably 800 to 1500, measured by gel permeation chromatography (GPC). When the structure and molecular weight of the epoxy(meth)acrylate are within the above-described ranges, an optical disc using the ultraviolet curable composition of the present invention is further improved in durability and light resistance. GPC was conducted using HLC-8020 manufactured by Tosoh Corporation and a column, GMHxl-GMHxl-G200Hxl-G1000Hxlw. The molecular weight was measured in terms of standard polystyrene using THF as a solvent at a flow rate of 1.0 ml/min, at a column temperature of 40° C., at a detector temperature of 30° C.

When epoxy(meth)acrylate is combined, the content is preferably 5 to 40% by mass, more preferably 5 to 30% by mass, and most preferably 20 to 35% by mass.

In addition, characteristics of a resultant cured film can be controlled using polyester(meth)acrylate, polyether(meth)acrylate, or polyurethane(meth)acrylate as another (meth)acrylate oligomer. When such an oligomer is contained, the content is preferably 10% by mass or less, more preferably 5% by mass or less, in order to maintain suitable heat resistance and the like for an optical disc intermediate layer without decreasing detachability of a cured product.

### (Photopolymerization Initiator)

In the present invention, a photopolymerization initiator can be used according to demand. As the photopolymerization initiator, any one of known initiators in common use can be used, but a molecular cleavage type or hydrogen extraction type is preferably used as the photopolymerization initiator. Examples of the photopolymerization initiator used in the present invention include molecular cleavage-type photopolymerization initiators, such as benzoine isobutyl ether, 2,4-diethylthioxanthone, 2-isopropylthioxanthone, benzyl, 1-hydroxycyclohexyl phenyl ketone, benzoine ethyl ether, benzyl dimethyl ketal, 2-hydroxy-2-methyl-1-phenylpropan-1-one, 1-(4-isopropylphenyl)-2-hydroxy-2-methylpropan-1-one, 2-methyl-1-(4-methylthiophenyl)-2-morpholinopropan-1-one, and the like; and hydrogen extraction-type photopolymerization initiators, such as benzophenone, 4-phenylbenzophenone, isophthalphenone, 4-benzoyl-4′-methyl-diphenyl sulfide, and the like.

### (Silicone Additive)

In the present invention, detachability from resins such as polycarbonate can be improved using a silicone additive. Examples of the silicone additive which can be used include silicone acrylate, such as ethylene oxide-modified silicone acrylate and the like; propylene oxide-modified silicone acrylate; and modified silicone oil, such as ethylene oxide-modified silicone oil, propylene oxide-modified silicone oil, and the like.

In particular, ethylene oxide-modified silicone acrylate, propylene oxide-modified silicone acrylate, ethylene oxide-modified silicone oil, propylene oxide-modified silicone oil, and the like can be preferably used.

The content of the silicone additive such as silicone acrylate, modified silicone oil, or the like is preferably 0.01 to 10 parts by mass, preferably 0.01 to 5 parts by mass, more preferably 0.1 to 1 part by mass, relative to 100 parts by mass of the (meth)acrylates other than the silicone additive contained in the ultraviolet curable composition.

As the silicone acrylate, for example, TEGORAD 2200N, 2500N, and 2100N (manufactured by Degussa Japan Co., Ltd.) and the like are preferred. As the modified silicone oil, for example, either a side chain modified type or terminal modified type may be used, and L-7001, L-7002, Y-7006 and the like manufactured by Dow Corning Toray Co., Ltd. can be used.

These silicone additives are particularly effective in decreasing adhesion to polycarbonate.

### (Other Additives)

Arbitrary components which constitute the composition of the present invention include the components described below and can be used within a range in which the advantage of the present invention is not degraded. Namely, examples of a sensitizer for the photopolymerization initiator include trimethylamine, methyldimethanolamine, triethanolamine, p-dimethylaminoacetophenone, ethyl p-dimethylaminobenzoate, isoamyl p-dimethylaminobenzoate, N,N-dimethylbenzylamine, 4,4′-bis(diethylamino)benzophenone, and the like. Further, an amine which causes no addition reaction with the above-described photopolymerizable compound may be combined. Of course, the sensitizer is preferably selected from these so as to have excellent solubility in an ultraviolet curable compound and not to inhibit ultraviolet permeability. In addition, the ultraviolet curable composition of the present invention may contain as additives a surfactant, a leveling agent, a thermal polymerization inhibitor, an antioxidant such as a hindered phenol, a phosphite, or the like, and a light stabilizer such as hindered amine or the like according to demand.

### (Characteristic of Composition)

The ultraviolet curable composition of the present invention having the above-mentioned configuration is capable of forming a rigid cured product with a higher crosslinking density, realizing high elastic modulus and a high glass transition temperature, and preventing deformation during recording of information. Also, the ultraviolet curable composition of the present invention is capable of realizing a cured film having rigidity and appropriate flexibility and exhibiting excellent detachability from general-purpose resins, particularly polycarbonate.

The cured product of the ultraviolet curable composition of the present invention has an adhesive force to polycarbonate of 4 kg/cm² or less, preferably 3 kg/cm² or less, and more preferably 1 kg/cm² or less.

The adhesive force for polycarbonate of the cured product of the ultraviolet curable composition of the present is measured by, for example, the following test. A polycarbonate plate having a thickness of 1.2 mm is coated with the ultraviolet curable composition, and the composition is UV-cured. Then, a double-face tape is applied to a 10 mm square attachment made of stainless steel, and then the attachment is bonded to the cured film. The cured film in the periphery of the attachment is cut with a cutter knife. Then, the 10 mm square attachment made of stainless steel is pulled in a 90° direction at a rate of 125 mm/min using motorized longitudinal electric stand MAX500N manufactured by Imada Co., Ltd. to measure adhesive force.

The ultraviolet curable composition of the present invention has a B-type viscosity at 25° C. of 1,000 mPa·s or less, preferably 50 to 1,000 mPa·s, and more preferably 50 to 500 mPa·s. In this case, an intermediate layer of an optical disc, particularly an intermediate layer having a thickness of 5 to 7 μm, can be preferably formed.

The cured film of the ultraviolet curable composition of the present invention preferably has an elastic modulus at 100° C. of 500 to 4,000 MPa and more preferably 1,000 to 3,500 MPa. When the elastic modulus lies within this range, a transferred pit shape can be preferably maintained for changes in heat and humidity.

### [Optical Disc]

Next, an optical disc of the present invention is described. An optical disc of the present invention has at least one light-reflecting layer on a substrate and a cured layer provided between the substrate and the light-reflecting layer or between adjacent two light-reflecting layers, the cured layer being composed of a cured product of the above-described ultraviolet curable composition and having a concave-convex pattern on the surface thereof. The concave-convex pattern includes at least one of a pit, a groove, and a land.

In the optical disc of the present invention, the concave-convex pattern can be produced using polycarbonate or the like, which is a general-purpose resin, as a stamp. In mass production of optical discs as recording media, the optical disc of the present invention which can use such an inexpensive stamp can significantly decrease the manufacturing cost as compared with conventional optical discs.

Examples of the configuration of the optical disc include (i) a configuration in which at least a first information recording layer, a first light-reflecting layer, a light-transmitting layer, a second information recording layer, and a second light-reflecting layer are laminated in order on a substrate, the light-transmitting layer being composed of a cured product of the ultraviolet curable composition of the present invention, being laminated with the second information recording layer, and having a concave-convex pattern on the surface thereof; (ii) a configuration in which at least a first light-reflecting layer, a first information recording layer, a first light-transmitting layer, a second light-reflecting layer, a second information recording layer, and a second light-transmitting layer are laminated in order on a substrate, the first light-transmitting layer being composed of a cured product of the ultraviolet curable composition of the present invention and having a concave-convex pattern on the surface laminated with the second light-reflecting layer; and the like. The optical disc may have a configuration in which an information recording layer and a light-reflecting layer are further laminated to have three or more information recording portions.

Examples of optical discs having the configuration (i) include dual-layer DVD-R and dual-layer HD-DVD-R. In this case, the thickness of the light-transmitting layer is about 30 to 60 μm.

Examples of optical discs having the configuration (ii) include Blu-Ray Disc. The light-transmitting layer preferably sufficiently transmits blue laser at an oscillation wavelength of 370 to 430 nm. The thickness of the light-transmitting layer is in the range of 50 to 150 μm, and particularly preferably 75 to 150 μm. The thickness of the light-transmitting layer is generally set to about 100 μm. In the configuration having the two light-transmitting layers, preferably, the thickness of the first light-transmitting layer is 10 to 40 μm, and the thickness of the second light-transmitting layer is 90 to 60 μm. Since the thickness significantly influences light transmittance and signal reading and recording, it is necessary to sufficiently control the thickness. The light-transmitting layer may include a single cured layer having the thickness or a laminate of a plurality of layers.

When a cured product of the ultraviolet curable composition of the present invention is used as the light-transmitting layer, the elastic modulus of the cured product at 100° C. is preferably 500 to 4,000 MPa and more preferably 1,000 to 3,500 MPa. With an elastic modulus within this range, the cured product has the excellent effect of preventing deformation due to heat produced by writing information and excellent detachability from polycarbonate.

When a cured product of the ultraviolet curable composition of the present invention is used as the light-transmitting layer, a laser beam at an oscillation wavelength of about 500 nm and a blue laser at 370 to 430 nm are preferably transmitted with high efficiency. With a thickness of 100 the transmittance of light at 405 nm is preferably 85% or more and particularly preferably 90% or more.

As the light-reflecting layer, any material which can reflect laser light and form an optical disc capable of recording/reproduction can be used. For example, metals such as gold, copper, aluminum, and the like, alloys thereof, and inorganic compounds such as silicon, can be used. When a blue laser is used, silver or an alloy containing silver as a main component is preferably used because of the high reflectance of light near 400 nm. The light-reflecting layer can be produced by forming a thin film by a method such as sputtering, vapor deposition, or the like using such a material. If required, the light-reflecting layer can be formed as a semitransparent light-reflecting layer.

As the substrate, a disc-shaped circular resin substrate can be used, and polycarbonate can be preferably used as the resin. In a reproduction-only optical disc, pits for carrying information on the substrate are formed on a surface laminated with the light-reflecting layer.

In a writable disc, an information recording layer is provided between a light-reflecting layer and a light-transmitting layer. The information recording layer may be any one of a phase change-type recording layer, a magneto-optical recording layer, and an organic dye-type recording layer as long as it is capable of information recording/reproduction.

When the information recording layer is a phase change-type recording layer, the information recording layer generally includes a dielectric layer and a phase change film. The dielectric layer is required to have the function to absorb heat generated in the phase change layer and the function to control the reflectance of the disc, and a mixed composition of ZnS and SiO₂ is used. The phase change film produces a difference in reflectance between an amorphous state and a crystalline state due to a phase change of the film, and a Ge—Sb—Te, Sb—Te, or Ag—In—Sb—Te alloy can be used.

The organic dye used for the organic dye-type recording layer, other than azo dyes, is not particularly limited as long as pits can be formed by laser light used for recording. Examples of the organic dye include cyanine dyes, phthalocyanine dyes, naphthalocyanine dyes, anthraquinone dyes, triphenylmethane dyes, pyrylium or thiapyrylium salt dyes, squalirium dyes, croconium dyes, formazan dyes, metal complex dyes, and the like. In addition, a singlet oxygen quencher may be mixed in the dye. Preferred examples of the quencher include metal complexes of acetylacetonate, bisditio-α-diketone, bisditiol such as bisphenyldithiol, thiocatechol, salicylaldehyde oxime, thiobisphenolate, and the like. Also, amine quenchers such as an amine compound having nitrogen radical cation, hindered amine, and the like are preferred. The materials used for the respective information recording layers may be the same or different.

The optical disc of the present invention may be configured to have a cured product layer of the ultraviolet curable composition, the layer having a concave-convex pattern, and the optical disc can be used for manufacturing DVDs such as write once DVD-R and DVD+R, dual-layer DVD-R and DVD+R, rewritable DVD-RW, DVD+RW, DVD-RAM, and the like; optical discs each having a light-transmitting layer formed on a substrate by laminating a cured film of an ultraviolet curable composition, for example, next-generation optical discs (trade name “Blu-ray”, trade name “HD-DVD”) using blue-violet laser as laser light for reading and writing information, and the like.

### [Method for Manufacturing Optical Disc]

The optical disc of the present invention is preferably manufactured by the manufacturing method including the steps of bonding the ultraviolet curable composition of the present invention between a substrate having a light-reflecting layer and a stamp having a concave-convex pattern on a surface thereof, at least the surface having the concave-convex pattern being composed of polycarbonate; irradiating the ultraviolet curable composition with ultraviolet light to form a light-transmitting layer composed of a cured product of the ultraviolet curable composition; and separating the stamp from the light-transmitting layer to form the light-transmitting layer having the concave-convex pattern.

The substrate having the light-reflecting layer may have the light-transmitting layer as an outermost layer or another layer as an outermost layer, such as an information recording layer or the like laminated on the light-reflecting layer. The light-transmitting layer having the concave-convex pattern including grooves and pits can be formed on the substrate having the light-reflecting layer by the above-described steps. A light-transmitting layer and an information recording layer may be further formed on the light-reflecting layer to manufacture a multilayer optical disc. In addition, a light-transmitting layer not having a concave-convex pattern or another substrate is laminated on the outermost layer.

A reproduction-only optical disc is formed by laminating a light-reflecting layer on a substrate having a concave-convex patter on a surface thereof, bonding the ultraviolet curable composition of the present invention between the light-reflecting layer and a stamp having a concave-convex pattern on a surface thereof, at least the surface having the concave-convex pattern being composed of polycarbonate; irradiating the ultraviolet curable composition with ultraviolet light to form a light-transmitting layer composed of a cured product of the ultraviolet curable composition; separating the stamp from the light-transmitting layer to form the light-transmitting layer having the concave-convex pattern; further forming a light-reflecting layer, and then laminating the same light-reflecting layer, a light-reflecting layer as an outermost layer, or a substrate.

An optical disc capable of recording/reproduction is manufactured by, for example, the following manufacturing method (I) or (II):
(I) A method for manufacturing an optical disc including at least a first information recording layer, a first light-reflecting layer, a light-transmitting layer, a second information recording layer, and a second light-reflecting layer which are laminated in order on a substrate, the method including:
   (1) a step of forming in order the first information recording layer and the first light-reflecting layer on the substrate;
   (2) a step of bonding the ultraviolet curable composition of the present invention between the first light-reflecting layer and a stamp having a concave-convex pattern on a surface thereof, at least the surface having the concave-convex pattern being composed of polycarbonate, irradiating the ultraviolet curable composition with ultraviolet light to form the light-transmitting layer composed of a cured product of the ultraviolet curable composition, and then separating the light-transmitting layer from the stamp to form the light-transmitting layer having the concave-convex patter formed thereon; and
   (3) laminating in order the second information recording layer and the second light-reflecting layer on the light-transmitting layer.
(II) A method for manufacturing an optical disc including at least a first light-reflecting layer, a first information recording layer, a first light-transmitting layer, a second light-reflecting layer, a second information recording layer, and a second light-transmitting layer which are laminated in order on a substrate, the method including:
   (1′) a step of forming the first light-reflecting layer and the first information recording layer on the substrate;
   (2′) a step of bonding the ultraviolet curable composition of the present invention between the first information recording layer and a stamp having a concave-convex pattern on a surface thereof, at least the surface having the concave-convex pattern being composed of polycarbonate, irradiating the ultraviolet curable composition with ultraviolet light to form the first light-transmitting layer composed of a cured product of the ultraviolet curable composition, and then separating the first light-transmitting layer from the stamp to form the light-transmitting layer having the concave-convex patter formed thereon; and
   (3′) laminating in order the second light-reflecting layer, the second information recording layer, and the second light-transmitting layer on the light-transmitting layer.

The above-described method (I) or (II) can form an optical disc having two information recording layers. However, the steps (2) and (3) or (2′) and (3′) may be repeated to manufacture an optical disc three or four information recording layers. In the step (3) or (3′), the light-reflecting layer, the information recording layer, and the light-transmitting layer may be laminated in order, or a previously formed laminate of these layers may be laminated at a time.

The manufacturing method of the present invention can use polycarbonate as the stamp and can thus manufacture an optical disc at low cost. In addition, a stamp made of another general-purpose resin, for example, an acrylic resin, a methacrylic resin, a polycarbonate resin, a polyester resin, a polystyrene resin, an epoxy resin, or the like, can be used.

Ultraviolet irradiation can be performed by, for example, a continuous irradiation method using a metal halide lamp, a high-pressure mercury lamp, or the like, or a flash exposure method described in U.S. Pat. No. 5,904,795. The flash exposure method is more preferred because curing can be efficiently performed. The gel fraction of the cured product is preferably 70% to 100% and more preferably 85% to 100%.

### Embodiment

An example of the optical disc of the present invention in which a dye recording layer is used as an information recording layer in the above-described configuration (i) is described below.

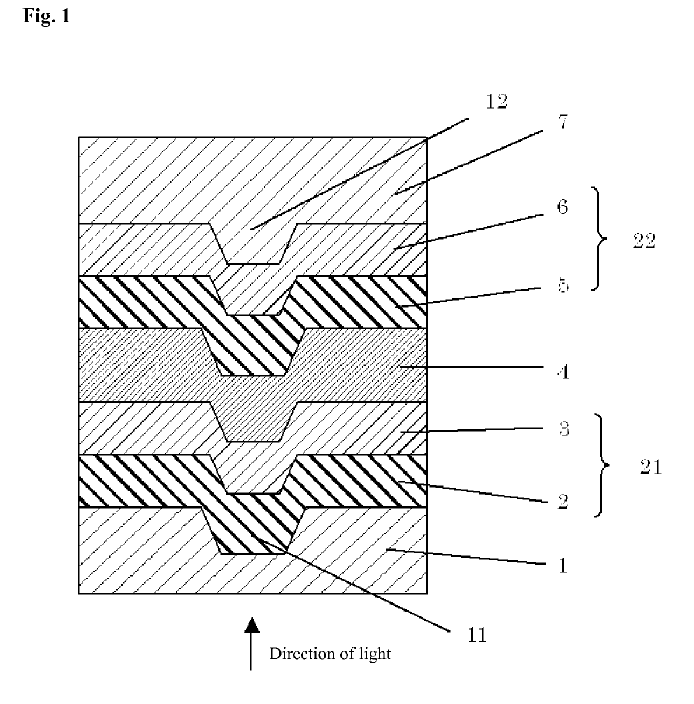

An example of the optical disc using the ultraviolet curable composition for an optical disc intermediate layer according to an embodiment of the present invention is an optical disc having a structure in which a dye recording layer (a₁), a semitransparent light-reflecting layer (t₁), a light-transmitting layer (c₁) of the ultraviolet curable composition for an optical disc intermediate layer of the present invention, a dye recording layer (b), and a light-reflecting layer (r) are laminated in that order, as shown in FIG. 1.

The optical disc shown in FIG. 1 is an optical disc having a structure in which a dye recording layer (a₁) 2, a semitransparent light-reflecting layer (t₁) 3, a light-transmitting layer (c₁) 4 of the ultraviolet curable composition, a dye recording layer (b) 5, a light-reflecting layer (r) 6, and a substrate (d₂) 7 are laminated in that order on a substrate (d₁) 1. In FIG. 1, the dye recording layer (a₁) 2 and the semitransparent light-reflecting layer (t₁) 3 form a first recording layer 21, and the dye recording layer (b) 5 and the light-reflecting layer (r) 6 form a second recording layer 22. In addition, the semitransparent light-reflecting layer (t₁) 3 and the dye recording layer (b) 5 are laminated opposite to each other with the light-transmitting layer (c₁) 4 of the ultraviolet curable composition provided therebetween. FIG. 1 also shows a convex recording track (groove) 11 (first recording layer) and a convex recording track (groove) 12 (second recording layer) in the light incident direction.

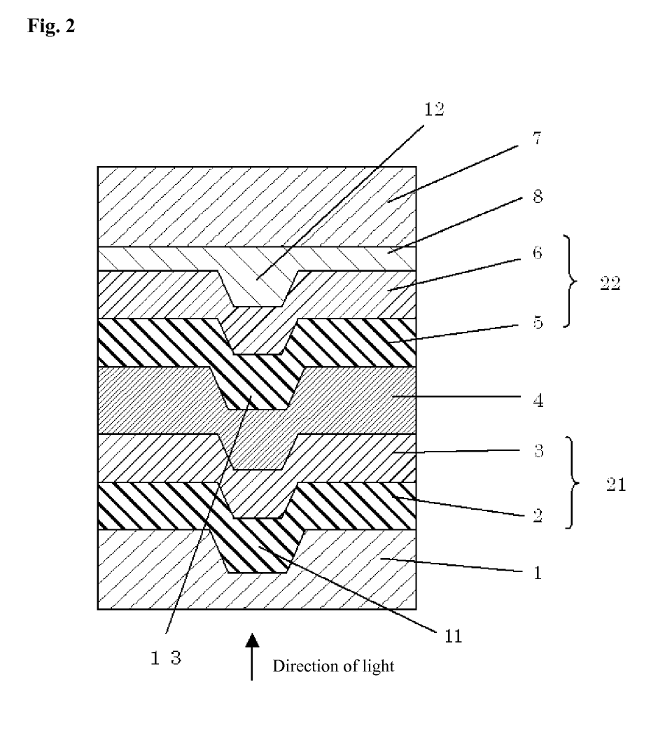

The optical disc of the present invention may include an adhesive layer 8 provided between the light-reflecting layer (r) 6 and the substrate (d₂) 7 (FIG. 2). Further, the optical disc may have a structure in which a dye recording layer (a₂) 31, a semitransparent light-reflecting layer (t₂) 32, and a light-transmitting layer (c₂) 33 of the ultraviolet curable composition are laminated to form at least one laminate (s) 23 between the light-transmitting layer (c₁) 4 and the dye recording layer (b) 5.

In this case, these layers are laminated so that the light-transmitting layer (c₁) 4 is in contact with the dye recording layer (a₂) 31, and the dye recording layer (b) 5 is in contact with the light-transmitting layer (c₂) 33. The light-transmitting layer (c₂) 33 is formed using the ultraviolet curable composition described in detail above.

When two or more laminates (s) 23 are laminated, the laminates are laminated with a light-transmitting layer of the ultraviolet curable composition, which is described in detail above, provided therebetween so that the dye recording layer (a₂) of one (s₁) of the laminates is in contact with the light-transmitting layer (c₂) of the other laminate (s₂) adjacent to the laminate (s₁).

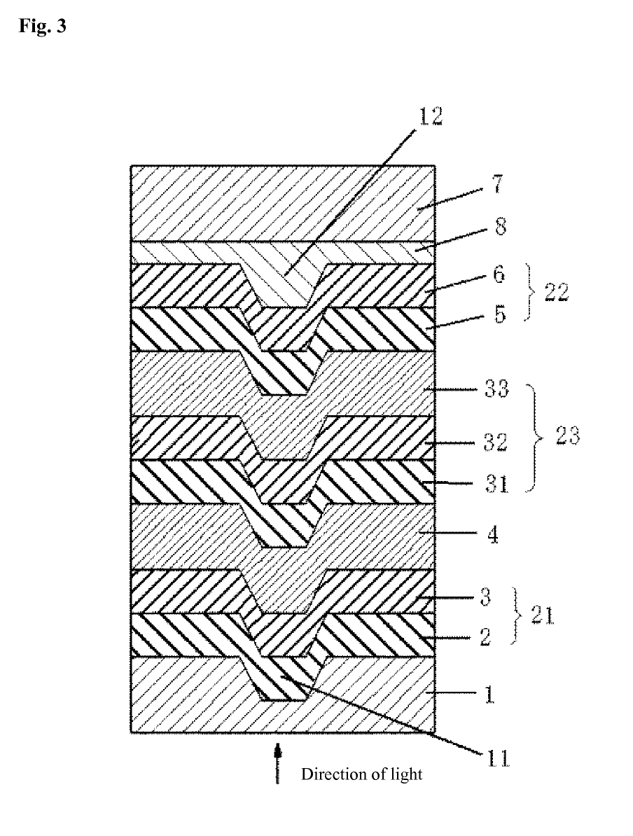

FIG. 3 shows an example of an optical disc in which only one laminate (s) 23 is further laminated on the first recording layer 21 of the optical disc shown in FIG. 2.

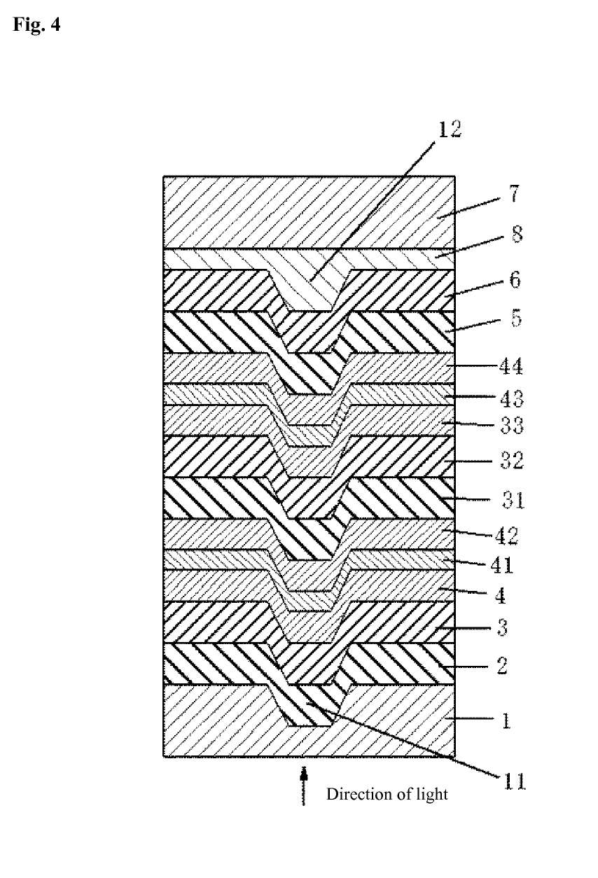

In the optical disc shown in FIG. 3, each of the light-transmitting layer (c₁) 4 and the light-transmitting layer (c₂) 33 may be a laminate of two or more light-transmitting layers. In a recent optical disc, the need for minimizing curvature of the disc has occurred with increases in capacity. Therefore, as shown in FIG. 4, a very flexible light-transmitting layer (c₃) 41 may be laminated on the light-transmitting layer (c₁) 4 in order to decrease curvature, and then the ultraviolet curable composition described in the present invention may be laminated as a light-transmitting layer (c₄) 42. Similarly, a very flexible light-transmitting layer (c₅) 43 may be laminated on the light-transmitting layer (c₂) 33 in order to decrease curvature, and then the ultraviolet curable composition described in the present invention may be laminated as a light-transmitting layer (c₆) 44.

The semitransparent light-reflecting layer has such appropriate light transmittance that recording and reproduction can be performed on and from the second recording layer. Specifically, the reflecting layer preferably has a transmittance of 40% or more for laser light for recording and reproducing information, and appropriate reflectance (generally 30% or more). The thickness of the semitransparent light-reflecting layer is preferably 50 nm or less, more preferably 30 nm or less, and most preferably 25 nm or less.

The light-reflecting layer of the second recording layer is required to have high reflectance. In addition, the light-reflecting layer preferably has high durability. In order to secure high reflectance, the thickness of the light-reflecting layer is preferably 20 nm or more, more preferably 30 nm or more, and still more preferably 50 nm or more. However, in order to shorten the tact time and decrease cost, the light-reflecting layer is preferably thin to some extent, and the thickness is generally 400 nm or less, preferably 300 nm or less.

The thickness of the substrate is preferably 0.1 to 2.0 mm and more preferably 0.3 to 1.5 mm.

These optical discs can be manufactured by, for example, the following steps. The method for manufacturing the optical disc shown in FIG. 1 is described.

First, a polycarbonate resin is injection-molded to prepare the substrate (d₁) 1 having a guide groove referred to as the recording track (groove) 11 for tracking laser light. Next, an azo dye is dissolved in a solvent and then applied to the surface of the recording track side of the substrate (d₁) 1 by spin coating or the like to form the dye recording layer (a₁) 2. Further, the semitransparent light-reflecting layer (t₁) 3 is formed on the dye recording layer (a₁) 2 by sputtering or vapor-depositing a silver alloy or the like to prepare the first recording layer 21.

Next, a polycarbonate resin is injection-molded to prepare the substrate (d₂) 7 having a guide groove referred to as the recording track (groove) 12 for tracking laser light. Next, the light-reflecting layer (r) 6 is formed on the substrate (d₂) 7 by sputtering or vapor-depositing a silver alloy or the like. Then, an azo dye is dissolved in a solvent and then applied to the surface on the recording track side of the substrate (d₂) 7 by spin coating or the like to form the dye recording layer (b) 5, preparing the second recording layer 22.

Then, the ultraviolet curable composition is applied on the surface of the semitransparent light-reflecting layer (t₁) 3 on the substrate (d₁) having the first recording layer, and combined with the dye recording layer (b) 5 of the substrate having the second recording layer by spin coating or the like. The laminated disc is irradiated with ultraviolet light from one or both surfaces thereof to cure the ultraviolet curable composition, thereby forming the light-transmitting layer (c₁) 4. As a result, the optical disc shown in FIG. 1 is formed.

The method for manufacturing the optical disc shown in FIG. 2 is described. First, a polycarbonate resin is injection-molded to prepare the substrate (d₁) 1 having a guide groove referred to as the recording track (groove) 11 for tracking laser light. Next, an azo dye is dissolved in a solvent and then applied to the surface of the recording track side of the substrate (d₁) 1 by spin coating or the like to form the dye recording layer (a₁) 2. Further, the semitransparent light-reflecting layer (t₁) 3 is formed on the dye recording layer (a₁) 2 by sputtering or evaporating a silver alloy or the like to prepare the first recording layer 21.

Further, the light-transmitting layer (c₁) 4 of the ultraviolet curable composition for an optical disc intermediate layer of the present invention is formed on the first recording layer 21. At the same time, a recording track (groove) 13 is transferred to the surface using a stamp. The step of transferring the recording track (groove) 13 is as follows: The ultraviolet curable composition for an optical disc intermediate layer of the present invention is applied onto the semitransparent light-reflecting layer (t₁) 3 of the substrate (d₁) 1 and combined with a stamp for forming the recording track (groove) 13 thereon. The combined disc is irradiated with ultraviolet light from one or both surfaces to cure the composition of the present invention. Then, the stamp is separated to prepare an optical disc substrate having the recording track (groove) 13 provided in the light-transmitting layer (c₁) 4. The sample is not limited as long as it has sufficient detachability from the light-transmitting layer (c₁) 4, but a resin stamp is preferred from the viewpoint of productivity and cost. Examples of a material which can be used for the resin stamp include resins, such as acrylic resin, methacrylic resins, polycarbonate resins, polyolefin resins (particularly amorphous polyolefin), polyester resins, polystyrene resins, epoxy resins, and the like. Since the light-transmitting layer (c₁) 4 of the ultraviolet curable composition for an optical disc intermediate layer of the present invention is decreased in adhesion to polycarbonate, a polycarbonate resin can be used.

Then, an azo dye is dissolved in a solvent and then applied by spin coating or the like to the surface of the light-transmitting layer (c₁) 4 of the optical disc substrate on the side which has the recording track (groove) 13, to form the dye recording layer (b) 5. Further, the light-reflecting layer (r) 6 is formed on the dye recording layer (b) 5 by sputtering or vapor-depositing a silver alloy or the like to prepare the second recording layer 22.

Next, a polycarbonate resin is injection-molded to prepare the substrate (d₂) 7 not having a recording layer. An ultraviolet curable adhesive is applied on the surface of the light-reflecting layer (r) 6 of the substrate having the two recording layers formed as described above and combined with the substrate (d₂) 7. The combined disc is irradiated with ultraviolet light from one or both surfaces thereof to cure the ultraviolet curable adhesive, forming an adhesive layer 8. As a result, the optical disc shown in FIG. 2 can be formed.

The method for manufacturing the optical disc shown in FIG. 3 is described. A first recording layer 21 is formed on the substrate (d₁) 1 shown in FIG. 3, and a light-transmitting layer (c₁) 4 of the ultraviolet curable composition, which has a recording track (groove) is formed on the first recording layer 21 by the same methods as those for forming the first recording layer 21 and the light-transmitting layer (c₁) 4, respectively, of the optical disc shown in FIG. 2. Next, a laminate (s) 23 shown in FIG. 3 is formed by the same method as that for forming the first recording layer 21 of the optical disc shown in FIG. 2. Then, a second recording layer 22 is formed by the same method as that for forming the second recording layer 22 of the optical disc shown in FIG. 2. Finally, an ultraviolet curable adhesive is applied on the surface of the light-reflecting layer (r) 6 of the second recording layer 22 and combined with a substrate (d₂) 7 not having a recording layer. The combined disc is irradiated with ultraviolet light from one or both surfaces thereof to cure the ultraviolet curable adhesive, forming an adhesive layer 8. As a result, the optical disc shown in FIG. 3 can be formed.

### Examples

The present invention is described in further detail with reference to examples, but the present invention is not limited to these examples.

### Examples and Comparative Examples

### <Preparation of Composition and Optical Disc Sample>

The composition materials of each of the mixed compositions shown in Tables 1 to 7 (in the tables, each mixing value represents parts by mass) were heated and dissolved at 60° C. for 3 hours to prepare an ultraviolet curable composition of each of examples and comparative examples.

Next, the composition of each of the examples and comparative examples was applied onto a optical disc polycarbonate substrate having a thickness of 1.2 mm and a diameter of 120 mm so that the thickness was 30 The composition was irradiated with 15 shots of ultraviolet light at a voltage of 1450 V using Flash Lamp SBC-17 manufactured by Ushio Electric Inc. to form a cured film, preparing an optical disc sample for evaluation. However, the compositions of Comparative Examples 11 and 12 were not cured under these conditions but cured using a mercury lamp manufactured by Eye Graphics Co., Ltd. to prepare optical disc samples for evaluation.

### <Adhesive Force Measurement, Peel Test>

A double-face tape was applied to a 10 mm square attachment made of stainless steel, and then the attachment was bonded to the cured film of each of the optical disc samples. The cured film in the periphery of the attachment was cut with a cutter knife. Then, the 10 mm square attachment made of stainless steel was pulled in a 90° direction at a rate of 125 mm/min using motorized longitudinal electric stand MAX500N manufactured by Imada Co., Ltd. to measure adhesive force during peeling. Also, in the peel test, the conditions of the polycarbonate substrate after peeling were observed. The evaluation criteria of the peel test were as follows:

⊙: Feeling was good, and cracks or defects were not observed in the polycarbonate substrate and the cured film of the peeled surfaces.

◯: Resistance slight occurred during peeling, and cracks or defects were not observed in the polycarbonate substrate and the cured film of the peeled surfaces.

×: Cracks were observed in the peeled surfaces or detects occurred without peeling.

### <Measurement of Elastic Modulus>

Each ultraviolet durable composition was applied on a glass plate so that the thickness of a dry coating was 100 ρm and then cured using a metal halide lamp (provided with a cold mirror, lamp output 120 W/cm) with 0.5 J/cm² in a nitrogen atmosphere. The elastic modulus of the cured film was measured with an automatic dynamic viscoelasticity meter (Reometric Scientific Corporation, SOLID ANALYZER RSA-III) to determine dynamic modulus of elasticity E′ at 100° C. The E′ was regarded as elastic modulus.

Measurement Conditions

(1) Sample size: width 6 mm, length 20 mm

(2) Strain: 0.1%

(3) Frequency: 3.5 Hz

(4) Heating rate: 3° C./min

TABLE 1

| | Exam- | Exam- | Exam- | Exam- | Exam- |
|---|---|---|---|---|---|
| | ple 1 | ple 2 | ple 3 | ple 4 | ple 5 |
| DPHA | 42 | 42 | 42 | 42 | 42 |
| TMPTA | 20 | 20 | 20 | | |
| PETA | | | | 20 | |
| TAEIC | | | | | 20 |
| TMP TMA | | | | | |
| TMP (EO)TA | | | | | |
| TCDDA | 20 | 23 | 20 | 20 | 20 |
| TCDDMA | | | | | |
| NPGDA | | | | | |
| R-6O4 | | | | | |
| IB-X | 10 | 7 | 10 | 10 | 10 |
| IB-XA | | | | | |
| Epoxy acrylate | | | | | |
| Epoxy acrylate | | | | | |
| Tegorad2200N | | | 0.2 | | |
| HCPK | 8 | 8 | 8 | 8 | 8 |
| Total | 100 | 100 | 100.2 | 100 | 100 |
| Elasitic modulus | 3000 | 2500 | 2200 | 2300 | 2100 |
| (MPa)100° C. | | | | | |
| PC Adhesive force | 2.37 | 3.52 | 1.55 | 0.96 | 1.06 |
| (kg/cm2) | | | | | |
| Peel test | ⊚ | ◯ | ⊚ | ⊚ | ⊚ |

TABLE 2

| | Exam- | Exam- | Exam- | Exam- | Exam- |
|---|---|---|---|---|---|
| | ple 6 | ple 7 | ple 8 | ple 9 | ple 10 |
| DPHA | 42 | 42 | 20 | 20 | 20 |
| TMPTA | | | 32 | 32 | |
| PETA | | | | | |
| TAEIC | | | | | |
| TMP TMA | 20 | 20 | | | 32 |
| TMP (EO)TA | | | | | |
| TCDDA | 20 | 20 | | 30 | 30 |
| TCDDMA | | | 30 | | |
| NPGDA | | | | | 5 |
| R-6O4 | | | | | |
| IB-X | 10 | | 10 | 10 | 5 |
| IB-XA | | 10 | | | |
| Epoxy acrylate | | | | | |
| Epoxy acrylate | | | | | |
| Tegorad2200N | | | 0.2 | | |
| HCPK | 8 | 8 | 5 | 5 | 5 |
| Total | 100 | 100 | 97.2 | 97 | 97 |
| Elasctic modulus | 2000 | 1900 | 1600 | 1700 | 1600 |
| (MPa)100° C. | | | | | |
| PC adhesive force | 0.54 | 0.86 | 1.03 | 3.20 | 3.26 |
| (kg/cm2) | | | | | |
| Peel test | ⊚ | ⊚ | ⊚ | ◯ | ◯ |

TABLE 3

| | Exam- | Exam- | Exam- | Exam- | Exam- |
|---|---|---|---|---|---|
| | ple 11 | ple 12 | ple 13 | ple 14 | ple 15 |
| DPHA | 20 | 20 | 20 | 40 | 42 |
| TMPTA | | | | 20 | 20 |
| PETA | | | | | |
| TAEIC | | | | | |
| TMPTMA | 32 | 32 | 32 | | |
| TMP(EO)TA | | | | | |
| TCDDA | 30 | 30 | | 15 | |
| TCDDMA | | | 30 | | |
| NPGDA | | | | | |
| R-6O4 | | | | | 20 |
| IB-X | 10 | 10 | 10 | 10 | 10 |
| IB-XA | | | | | |
| Epoxy acrylate | | | | 7 | |
| Epoxy acrylate | | | | | |
| Tegorad2200N | | 0.2 | 0.2 | | |
| HCPK | 5 | 5 | 5 | 8 | 8 |
| Total | 97 | 97.2 | 97.2 | 100 | 100 |
| Elastic modulus | 1700 | 1900 | 1000 | 2000 | 2900 |
| (MPa)100° C. | | | | | |
| PC Adhesive force | 1.08 | 0.79 | 0.63 | 0.90 | 1.00 |
| (kg/cm2) | | | | | |
| Peel test | ⊚ | ⊚ | ⊚ | ⊚ | ⊚ |

TABLE 4

| | Exam- | Exam- | Exam- | Exam- | Exam- |
|---|---|---|---|---|---|
| | ple 16 | ple 17 | ple 18 | ple 19 | ple 20 |
| DPHA | | | | 40 | 40 |
| TMPTA | 37 | | 10 | 20 | 20 |
| PETA | | | 32 | | |
| TAEIC | | | | | |
| TMPTMA | | 30 | | | |
| TMP(EO)TA | | | | | |
| TCDDA | 15 | 15 | 20 | 15 | |
| TCDDMA | | | | | 15 |
| NPGDA | | | | | |
| R-6O4 | | | | | |
| IB-X | 10 | | 10 | 10 | 10 |
| IB-XA | | 15 | | | |
| Epoxy acrylate | 30 | 32 | 20 | | |
| Epoxy acrylate | | | | 7 | 7 |
| Tegorad2200N | | | 3 | 0.2 | 0.2 |
| HCPK | 8 | 8 | 8 | 8 | 8 |
| Total | 100 | 100 | 103 | 100.2 | 100.2 |
| Elastic modulus | 750 | 1100 | 1200 | 1800 | 1800 |
| (MPa)100° C. | | | | | |
| PC adhesive force | 0.75 | 0.58 | 0.91 | 1.17 | 0.64 |
| (kg/cm2) | | | | | |
| Peel test | ⊚ | ⊚ | ⊚ | ⊚ | ⊚ |

TABLE 5

| | Comparative | Comparative | Comparative | Comarative | Comparative |
|---|---|---|---|---|---|
| | Example 1 | Example 2 | Example 3 | Example 4 | Example 5 |
| DPHA | 42 | 42 | 42 | 42 | 42 |
| TMPTA | 20 | 20 | 20 | 20 | 42 |
| PETA | | | | | |
| TAEIC | | | | | |
| TMPTMA | | | | | |
| TMP(EO)TA | | | | | |
| TCDDA | 25 | 28 | 20 | 20 | 4 |
| TCDDMA | | | | | |
| NPGDA | | | | | |
| R-6O4 | | | | | |
| IB-X | 5 | 2 | | | 4 |
| IB-XA | | | 10 | 10 | |
| Tegorad2200N | | | | 0.2 | |
| HCPK | 8 | 8 | 8 | 8 | 8 |
| Total | 100 | 100 | 100 | 100.2 | 100 |
| Elastic modulus | 2200 | 2200 | 1800 | 1800 | 2600 |
| (MPa) 100° C. | | | | | |
| PC adhesive force | 4.94 | 10.36 | 4.49 | 4.85 | 8.39 |
| (kg/cm2) | | | | | |
| Peel test | X | X | X | X | X |

TABLE 6

| | Comparative | Comparative | Comparative | Comparative | Comparative |
|---|---|---|---|---|---|
| | Example 6 | Example 7 | Example 8 | Example 9 | Example 10 |
| DPHA | 15 | 20 | 20 | 20 | |
| TMPTA | 32 | 32 | | 32 | 30 |
| PETA | | | | | 30 |
| TAEIC | | | | | |
| TMPTMA | | | 32 | | |
| TMP(EO)TA | | | | | 2 |
| TCDDA | 35 | 30 | 30 | 30 | 30 |
| TCDDMA | | | | | |
| NPGDA | 10 | 5 | 10 | | |
| R-6O4 | | | | | |
| IB-X | | 5 | | | |
| IB-XA | | | | 10 | |
| Tegorad2200N | | | | | |
| HCPK | 8 | 5 | 5 | 5 | 8 |
| Total | 100 | 97 | 97 | 97 | 100 |
| Elastic modulus | 1700 | 1700 | 1600 | 1700 | 1600 |
| (MPa) 100° C. | | | | | |
| PC adhesive force | 11.91 | 10.14 | 4.11 | 11.60 | 18.00 |
| (kg/cm2) | | | | | |
| Peel test | X | X | X | X | X |

TABLE 7

| | Comparative | Comparative |
|---|---|---|
| | Example 11 | Example 12 |
| TMPTA | | 15 |
| HDDA | 20 | |
| IB-X | 47 | 47 |
| S-A | | 5 |
| urethane acrylate | 30 | 30 |
| HCPK | 3 | 3 |
| Total | 100 | 100 |
| Elastic modulus | 20.5 | 109 |
| (MPa) 100° C. | | |
| PC adhesive force | 14.8 | 13.9 |
| (kg/cm2) | | |
| Peel test | x | x |

Each of the compounds shown in Tables 1 to 7 is as follows:

DPHA: dipentaerythritol hexaacrylate “PH-4600” manufactured by Cognis Japan Co., Ltd.

TMPTA: trimethylolpropane triacrylate

PETA: pentaerythritol tetraacrylate “ ARONIX M-450” manufactured by Toagosei Co., Ltd.

TAEIC: tris(2-acryloyloxyethyl) isocyanurate

TMPTMA: trimethylolpropane trimethacrylate

TMP(EO)TA: triol triacrylate produced by adding 3 moles of ethylene oxide to 1 mole of trimethylolpropane

TCDDA: tricyclodecanedimethanol diacrylate

TCDDMA: tricyclodecanedimethanol dimethacrylate

NPGDA: neopentyl glycol diacrylate

R-604: compound represented by the above formula (1) wherein R₁ and R₅ are hydrogen atoms, R₂ and R₃ are methyl groups, and R₄ is an ethyl group (manufactured by Nippon Kayaku Co., Ltd.)

IBXA: isobornyl acrylate (manufactured by Osaka Organic Chemical Industry Ltd.)

IB-X: isobornyl methacrylate (manufactured by Kyoeisha Chemical Co., Ltd.)

Epoxy acrylate: bisphenol A epoxy acrylate “UNIDIC V5530” manufactured by DIC Corporation

Epoxy methacrylate: bisphenol A epoxy methacrylate “CN151” manufactured by Sartomer Japan Inc.

Urethane acrylate: polyurethane acrylate produced by reaction of 2 moles of 2-hydroxyethyl acrylate with a reaction product of 1 mole of polytetramethylene glycol having a molecular weight of 1200 and 2 moles of methylene bis(4-cyclohexylisocyanate)

TEGORAD 2200N: silicone additive (manufactured by Degussa Japan Co., Ltd.)

HCPK: 1-hydroxycyclohexyl phenyl ketone

Tables 1 to 7 indicate that when the ultraviolet curable compositions prepared in Examples 1 to 20 of the present invention are used, defects of the substrates or the cured films are not recognized in peeling. In particular, when the adhesive force is 3 or less, resistance little occurs in peeling, and thus peeling can be sufficiently performed.

On the other hand, in Comparative Examples 1 to 10, the cured films are strongly bonded to the polycarbonate substrates, and in Comparative Examples 2, 5 to 7, and 9 to 12, defects of 5 mm square or more occurs in the polycarbonate substrates. In Comparative Examples 1, 3, 4, and 8, cracks occur in the peeled surfaces. Further, in Comparative Examples 11 and 12, large energy is required for curing, and the resultant cured films exhibit low elastic modulus at a high temperature and low heat resistance.

### INDUSTRIAL APPLICABILITY

An ultraviolet curable composition for an optical disc intermediate layer of the present invention is capable of forming a cured product with high detachability from polycarbonate and thus forming a good concave-convex pattern without using an expensive olefin resin as a stamp. Therefore, the ultraviolet curable composition of the present invention can be preferably used for an intermediate layer for forming prepits and grooves of an optical disc. In addition, the method for manufacturing an optical disc using the ultraviolet curable composition for an optical disc intermediate layer of the present invention is capable of manufacturing an optical disc without using an expensive olefin resin and thus capable of manufacturing an optical disc at low cost.

1. An ultraviolet curable composition comprising:
a polyfunctional (meth)acrylate having three or more (meth)acryloyl groups per molecule,
a difunctional (meth)acrylate having two (meth)acryloyl groups per molecule, and
a monofunctional (meth)acrylate having one (meth)acryloyl group per molecule,
wherein
the content of the polyfunctional (meth)acrylate in the (meth)acrylates contained in the ultraviolet curable composition is 30 to 70% by mass,
the content of the monofunctional (meth)acrylate is 5 to 30% by mass,
the total content of a difunctional (meth)acrylate having an alicyclic structure and a monofunctional (meth)acrylate having an alicyclic structure is 10 to 50% by mass, and
the content of a methacrylate is 7% by mass or more.

2. The ultraviolet curable composition according to claim 1, wherein the polyfunctional (meth)acrylate is at least one selected from tris(2-acryloyloxyethyl) isocyanurate, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, and dipentaerythritol hexa(meth)acrylate.

3. The ultraviolet curable composition according to claim 1, wherein the difunctional (meth)acrylate having an alicyclic structure is at least one selected from tricyclodecanedimethanol di(meth)acrylate and pentacyclopentadecanedimethanol di(meth)acrylate, and the monofunctional (meth)acrylate having an alicyclic structure is at least one selected from isobornyl(meth)acrylate, dicyclopentenyl(meth)acrylate, and dicyclopentanyl(meth)acrylate.

4. The ultraviolet curable composition according to claim 1, wherein the methacrylate is at least one selected from tricyclodecanedimethanol dimethacrylate, isobornyl methacrylate, dicyclopentenyl methacrylate, and dicyclopentanyl methacrylate.

5. The ultraviolet curable composition according to claim 1, wherein a cured film formed by applying the ultraviolet curable composition according to claim 1 on a polycarbonate substrate so that the thickness after curing is 30 μm and then irradiating the ultraviolet curable composition with 15 shots of ultraviolet light at a voltage of 1450 V has an adhesive force of 4 kg/cm² or less when the cured film is pulled in a 90° direction at a rate of 125 mm/min.

6. The ultraviolet curable composition according to claim 1, wherein the B-type viscosity at 25° C. is 50 to 1,000 mPa·s.

7. The ultraviolet curable composition according to claim 1, wherein a cured film formed by irradiating the ultraviolet curable composition according to claim 1 with 15 shots of ultraviolet light at a voltage of 1,450 V so that the thickness after curing is 30 μm has an elastic modulus of 500 to 4,000 MPa.

8. An optical disc comprising at least two light-reflecting layers on a substrate and a light-transmitting layer provided between the adjacent two light-reflecting layers, the light-transmitting layer having a concave-convex pattern on the surface thereof and being composed of a cured product of the ultraviolet curable composition according to claim 1.

9. An optical disc comprising
a first information recording layer,
a first light-reflecting layer,
a light-transmitting layer,
a second information recording layer, and
a second light-reflecting layer
which are laminated in order on a substrate,
wherein the light-transmitting layer is composed of a cured product of the ultraviolet curable composition according to claim 1 and has a concave-convex pattern on the surface laminated with the second information recording layer as an intermediate layer so that recording or reproduction may be performed by light incident on a surface of the substrate.

10. An optical disc comprising
a first light-reflecting layer,
a first information recording layer,
a first light-transmitting layer,
a second light-reflecting layer,
a second information recording layer, and
a second light-transmitting layer
which are laminated in order on a substrate,
wherein the first light-transmitting layer is composed of a cured product of the ultraviolet curable composition according to claim 1 and has a concave-convex pattern on a surface laminated with the second light-reflecting layer so that recording or reproduction is performed by light incident on the surface of the substrate.

11. A method for manufacturing an optical disc including at least two light-reflecting layers on a substrate, the method comprising:
bonding the ultraviolet curable composition according to claim 1 between a substrate supporting the light-reflecting layers and a stamp having a concave-convex pattern on a surface thereof, wherein at least the surface of the stamp having the concave-convex pattern is composed of polycarbonate; and
irradiating the ultraviolet curable composition with ultraviolet light to form a light-transmitting layer composed of a cured product of the ultraviolet curable composition, and then separating the light-transmitting layer from the stamp to form the light-transmitting layer having the concave-convex pattern formed thereon.

12. A method for manufacturing an optical disc including at least a first information recording layer, a first light-reflecting layer, a light-transmitting layer, a second information recording layer, and a second light-reflecting layer which are laminated in order on a substrate, the method comprising:
(1) a step of laminating in order the first information recording layer and the first light-reflecting layer on the substrate;
(2) a step including substeps of
bonding the ultraviolet curable composition according to claim 1 between the first light-reflecting layer and a stamp having a concave-convex pattern on a surface thereof, at least the surface of the stamp having the concave-convex pattern being composed of polycarbonate,
irradiating the ultraviolet curable composition with ultraviolet light to form the light-transmitting layer composed of a cured product of the ultraviolet curable composition, and then
separating the light-transmitting layer from the stamp to form the light-transmitting layer having the concave-convex pattern; and
(3) a step of laminating in order the second information recording layer and the second light-reflecting layer on the light-transmitting layer.

13. A method for manufacturing an optical disc including at least a first light-reflecting layer, a first information recording layer, a first light-transmitting layer, a second light-reflecting layer, a second information recording layer, and a second light-transmitting layer which are laminated in order on a substrate, the method comprising:
(1′) a step of laminating in order the first light reflecting layer and the first information recording layer on the substrate;
(2′) a step including substeps of
bonding the ultraviolet curable composition according to claim 1 between the first information recording layer and a stamp having a concave-convex pattern on a surface thereof, at least the surface of the stamp having the concave-convex pattern being composed of polycarbonate,
irradiating the ultraviolet curable composition with ultraviolet light to form the first light-transmitting layer composed of a cured product of the ultraviolet curable composition, and then
separating the first light-transmitting layer from the stamp to form the first light-transmitting layer having the concave-convex pattern; and
(3′) laminating in order the second light-reflecting layer, the second information recording layer, and the second light-transmitting layer on the first light-transmitting layer.
